(19) United States
(12) Patent Application Publication
(10) Pub. No.: US 2013/0078877 A1
(43) Pub. Date: Mar. 28, 2013

(54) MULTI-PURPOSE AMPHIBIOUS VEHICLE

(71) Applicant: Jong Soo LEE, Seoul (KR)

(72) Inventor: Jong Soo LEE, Seoul (KR)

(21) Appl. No.: 13/631,835

(22) Filed: Sep. 28, 2012

(30) Foreign Application Priority Data
Sep. 28, 2011 (KR) 10-2011-0098206

(51) Int. Cl. B60F 3/00

(52) U.S. Cl. CPC B60F 3/0015
USPC 440/12.63

(57) ABSTRACT

When the multi-purpose amphibious vehicle moves on surfaces of any type of terrain, it runs on a rolling track by rolling friction faster than a critical speed. The multi-purpose vehicle can run very smoothly and economically with a single engine, can provide multi-terrain capability with no hesitation between surfaces of different types of terrains, and can go as fast on the surfaces of water, snow and ice as it can run on the surface of land. Journey between islands, use for arctic expeditions, higher speed entry along inland rivers, and on the other hand, operation on areas of marsh or swamp using lower ground pressure tracks are all possible with this multi-purpose amphibious vehicle.

### RELATED APPLICATION

This application claims priority form Korean Patent Application No. 10-2011-0098206 filed Sep. 28, 2011 in the Korean Intellectual Property Office, which is hereby incorporated by reference in its entirety.

### BACKGROUND

1. Technical Field

Since the development of the amphibious vehicle, the range of its applications has been quite diversified.

In accordance with various design aspects for amphibious vehicles corresponding to a wide range of applications including recreation exploration, search and rescue, and military purposes, innumerable new concepts and variations have been proposed. Accordingly, it is desirable to provide a multi-purpose amphibious vehicle. However, attempts at such generally follow an extension of approaches used mainly for vehicles being operated on the surface of water or land.

2. Discussion of the Background

Instead of land vehicles capable of moving only on wild fields, most amphibious vehicles have been developed based on a human desire that is not only focusing on a transportation means moving on the land and in the water but also freely on all terrain like areas of ice, snow, mud, marsh and swamp. This explains a main reason why most vehicles have been designed depending not on wheels but on the tracks (Lower Ground Pressure).

The conventional amphibious operation technology has not only depended upon the traction of wheels or tracks on land but also in or on the water, other propulsion systems such as screw drive or water jet.

By adopting this conventional amphibious operation manner, a vehicle requires two sets of engines and transmissions that could not only add the increase of weight, but also reduce conspicuously the merits of the vehicle in terms of environment and economy.

Also, even when a single engine has been utilized, an extra transmission is required. Further, such a special means that is to minimize the drag experienced by the wheels or the tracks used on the land has to be provided.

### SUMMARY

Accordingly, by overcoming the above noted difficulties, in order for embodiments of this invention to freely move on all the terrains, a new technology referred to as “all terrain ride on technology” is provided and is supported by elevation force.

### INTRODUCTION OF A NEW TECHNICAL FIELD

Up to the present, the known motion technologies on the surfaces of all the certain terrains (surfaces of land, water, snow, ice, swamp and marsh or mud), with no substitution to be figured out, are one of hydro-gliding as slipping on those surfaces and another of all terrain riding on with its traction by the rolling friction.

In order to secure its motional means by hydro-gliding on the surface of water, its possibility may be able to be judged by Froude Number (Non-dimensional Ratio of the vehicle's weight and inertia) that has been well known in the field of hydrodynamics.

That is,

$${Fr}_{N} = \frac{U}{\sqrt{g \times L}} \qquad ( Eq . 1 )$$

wherein “U” is the gliding speed of the vehicle, “g” is a gravity acceleration, and “L” is the length of vehicle's immersion line. In order for an embodiment of this invention to glide on the surface of water, its Froude Number is to arrive approximately at “1”.

Also, a multi-purpose amphibious vehicle according to an embodiment of the present invention should be driven by the rolling friction on the surface of water governed by the following “Lee Number” that judges the generation of elevation force, which can sustain the vehicle's weight at a certain instant during its momentum change.

$${L}_{N} = \frac{V}{g \times Δ T} \qquad ( Eq . 2 )$$

wherein “V” is such a speed that the track or tire of the vehicle is colliding against the mentioned surfaces or transferring onto them, “g” is a gravitational acceleration, and “ΔT” means a stay instant on the contact surface of the mentioned tracks or tires. Thus, for such a condition that this invention, a multi-purpose amphibious vehicle can run on the surface of water, the Lee Number should be equal to or greater than “1”.

Since an embodiment of this invention, the vehicle running on the surface of water, is driven by the rolling friction, this case can be regarded as one of Coulomb Friction. At this instance, the coefficient “μ” of friction can be expressed as follows.

$$μ = \begin{matrix}U \\ V\end{matrix} = \begin{matrix}{Fr}_{N} \\ {L}_{N}\end{matrix} \times √ \begin{matrix}L \\ g \times Δ {T}^{2}\end{matrix} \qquad ( Eq . 3 )$$

In practice, suppose an embodiment of this may be driven by much higher friction, with no slip condition on the surface of water, it could be realized that the mentioned frictional coefficient become “=1”.

As being described in the above, by utilizing the above equations 1-3, such a condition that this invention, a multi-purpose amphibious vehicle can move by its rolling friction on the surface of water can be obtained.

Also, the movement technology on the surfaces of all terrain, so called, “all terrain ride on technology” can be derived from such a law of nature that, in Newton Mechanics, “Momentum Change equals Its Impulse”. The momentum change of the mentioned vehicle at a certain instant over its critical speed is to be transferred to the contact material having a certain mass (for instance, the water on its surface) to generate “elevation force” as a reaction force. Depending upon the law of nature, the effect that the mentioned vehicle is keeping and running on the surfaces of all terrain has been progressed into “all terrain ride-on principle”. By applying this principle to embodiments of this invention, a multi-purpose amphibious vehicle that can move on the surfaces of all terrain is provided.

### ([Advanced Technology Publications])

### ([Patents])

1. Gibbs Technologies Ltd. British“Wheel Suspension and Retraction System” Registration No. (Date) U.S. Pat. No. 7,316,594 B2 (Jan. 8, 2008).
2. “All-Terrain Hostile Environment Vehicle” Registration No. (Date) U.S. Pat. No. 7,478,817 B1 (Jan. 20, 2009).

### ([Non-Patents])

1. Walter B Horne and Robert C. Dreber “Phenomena of Pneumatic Tire Hydroplaning” NASA TN D-2056, November 1963.
2. Lydéric Bocquet “The Physics of Stone Skipping” The Nature, October, 2002.

3. William A. Johnsen “Advances in the Design of Pavement Surfaces” A Dissertation WORCESTER POLYTECHNIC INSTITUTE Dec. 19, 1997

### Subjects to be Solved

The specifications of a future “All Terrain Ride On Vehicle” that a multi-purpose amphibious vehicle of 21^{st} century should provide can be summarized as the following 5 requirements;

a) In keeping its performance on the land, the drag of tracks of the multi-purpose amphibious vehicle on the surface of water should be minimized,

b) the multi-purpose amphibious vehicle should have safer and more economical performance both on the surfaces of land and water.

c) Even after having solved such a chronic problem that amphibious vehicles are slower on the surface of water, the manufacturing cost of the multi-purpose amphibious vehicle should be lowered.

d) The multi-purpose amphibious vehicle should be equipped with such a suspension that can keep the vehicle safer and at higher speeds on the surfaces of all types of terrain,

e) Such a multi-purpose amphibious vehicle that should be capable of equivalently alternating, with no hesitation, on the surfaces of land and water.

In spite of these requirements, in designing a multi-purpose amphibious vehicle, there has been no other suggestion except the known technology up to now which depends on the traction on the land and hydro-gliding on water at higher speed by utilizing all of three forces; buoyancy, lift, and air pressure.

In order to glide at higher speeds on the surface of water, vehicles require over two times of the power consumption spent on land. Thus, problems such as vision and hydro-movement becoming unstable by a severe porpoise effect even in lower waves and vibration and noise due to higher power consumption should be still solved for a multi-purpose amphibious vehicle.

Embodiments of the present invention address the problems as described above. The goal during moving on any terrain is to provide such a multi-purpose amphibious vehicle that over the critical speed, the rolling friction leads the track rolling on the surfaces. The multi-purpose amphibious vehicle can run very smoothly and economically with a single engine, can provide multi=terrain capability with no hesitation between surfaces of different types of terrains, and can go as fast on the surfaces of water, snow and ice as it can run on the surface of land. Journey between islands, use for arctic expeditions, higher speed entry along inland rivers, and on the other hand, operation on areas of marsh or swamp using lower ground pressure tracks are all possible with a multi-purpose amphibious vehicle according to an embodiment.

### Solution Means of Subjects

As discussed above, in order to develop a multi-purpose amphibious vehicle of 21^{st} century, the conventional technology is problematic. A new scheme “All Terrain Ride on Technology” is desirable.

Accordingly, embodiments of this invention involve a new principle of all terrain movement that starts from the principle in Newtonian physics that “change in momentum is equal to an impulse”. When a certain revolving object collides with a certain surface, it causes such a force that both surfaces meet and rotate together. Accordingly, it has been discovered that an object can move by elevation force on all the surfaces at higher speed over the critical speed.

The principle of all terrain movement for the embodiments of this invention can be explained as follows.

First, in order for an object to move, it requires a force as 2^{nd} law of Newton Mechanics.

F=M a (Eq. 4)

Wherein “M” is a mass of certain object or “ΔM” is its distributed mass, “a” as an acceleration is a time derivative of a certain velocity

$$“ \frac{Δ V}{Δ T} ” ,$$

and “F” is such a force that the mass “M” of a certain object or its distributed mass “ΔM” can stay on a certain surface. This can be described again as

F×ΔT=M×V (Eq. 5)

The left hand side becomes an impulse, and the right hand side results in momentum change, which is a derivation from the 2^{nd} law of Newton Mechanics. Starting from this law, in order for a certain object to exist on a certain surface, the time “ΔT” should have a value of certain instant. To do this, the force “F” that can sustain the weight of the object “M” or the distributed weight “ΔMg” is hereby defined as the “elevation force”, the value of which should be at least equal to the weight of object “F=Mg” or the distributed weight “F=ΔMg”.

At this time, the ratio of its impulse and momentum is defined as herein-below by a non-dimensional “Lee Number”, which is proposed by such a condition that a certain object should exist on a certain surface.

$${L}_{N} = \frac{V}{g \times Λ T} \qquad ( Eq . 6 )$$

Already, as being assumed in Eq. 5, suppose a certain object should exist on a certain surface, it is unequivocally known that the Lee Number is no less than “1”. In another words, it can be regarded that the momentum change of a certain object is transferred to a certain surface of the material to generate a reactive force, so called, “elevation force”.

Thus, such a speed that a certain object can exist on a certain surface by generating the elevation force is defined as a critical speed. The stay time “ΔT” at that instant is also defined as a critical instant of stay.

For the case that this critical speed and instant should happen, Eq. 5 is rewritten with its horizontal and vertical components against a certain surface and given by the following.

Mg×ΔT=M×ΔV (Eq.7a)

μMg×ΔT=M×ΔU (Eq.7b)

Wherein“μ” has been regarded as the coefficient of Coulomb friction. The division of Eq. 7a by Eq. 7b results in the following relationship.

$$μ = \frac{Δ U}{Δ V} \qquad ( Eq . 8 )$$

Since it has been assumed that embodiments of this invention be moving by the rolling friction on a certain surface, by applying no slip condition, it could be known that the horizontal and vertical momentum changes become identical.

Now, in order for a certain object to move by the elevation force on a certain surface, the generated elevation force as a reactive force by a transferred momentum to a certain material (wherein “Water”) should be proportional to the square of colliding speed. Then, it can be expressed as follows.

$$Mg = \frac{1}{2} {ρ}_{W} {AV}_{C}^{1} {C}_{D} \qquad ( Eq . 9 )$$

wherein “A” is such an area that a certain object “M” contacts a material with its density “ρ_{w}”. “C_{D}” as a general drag coefficient is known to have approximately its experimental value of “0.7” for the case of tire but the case of this invention has its experimental value of about “1.0” because its contact surface is a planar flat track. For this case, the critical speed “V_{c}” is given by

$${V}_{C} = \sqrt{\frac{2 Mg}{{ρ}_{W} A {C}_{D}}} \qquad ( Eq . 10 )$$

wherein it has been assumed that the speed of a certain object be varied to “ΔV=V_{C}” after its collision with a certain surface i.e. its contact speed be closing onto zero. Then, since the case that Lee Number of Eq. 6 becomes “1” is a critical condition, the critical instant “ΔT” is given by

$$Δ T = \frac{{V}_{C}}{g} \qquad ( Eq . 11 )$$

Now, since such a condition that this invention, a multi-purpose amphibious vehicle is capable of moving on a certain surface by its track has been discovered, being based upon this, it is applied equivalently to the line speed of the track of this invention, a multi-purpose amphibious vehicle as follows,

$${V}_{ C} = \frac{π R}{Δ T} \qquad ( Eq . 12 )$$

wherein “R” is a radius of the tire inside of the track of this invention, a multi-purpose amphibious vehicle. Also, the relationships between a radius of tire and both of the critical instant and the critical speed are given by

$$\begin{matrix}Δ T = \sqrt{\frac{π R}{g}} & ( Eq . 13 a ) \\ {V}_{C} = \sqrt{π R \times g} & ( Eq . 13 b )\end{matrix}$$

From the above critical conditions, the size

$$( R = \frac{g \times Δ {T}^{2}}{π} )$$

of tire being fit for this invention, a multi-purpose amphibious vehicle can be determined. In consideration of vehicle's stability during its move on the surface of water, in order for its center of gravity to be positioned forward from its center of pressure, the numbers of frontal and rear tires by following the shared distribution of weight can be determined. The required power can be obtained in accordance with the maximum speed “U_{Max}” of the vehicle by the following formula.

$$HP = \frac{Mg \times {U}_{Ma x} + \text{?} ρ \times {A}_{D} \times \text{?}}{η \times 750} \\ \text{?} \text{indicates text missing or illegible when filed} \qquad ( 14 )$$

In Eq. 14, “ρ” is the density of air, “A_{D}” is a frontal drag area of the vehicle, And “η” an efficiency of power transmission. Taking it for instance: in case the full loaded weight of an embodiment of this invention weighs 3 tons, and the maximum moving speed on the surface of water reaches 50 knots, it requires a diesel engine of 250 HP as a power source.

### Effect

As an embodiment of this invention is related to a multi-purpose amphibious vehicle depending on “All Terrain Ride-On Ability”, during its movement on the surface of any terrain, it is not gliding on the mentioned surface over the critical speed but rolling with its track by the rolling friction. Thus, the multi-purpose amphibious vehicle can run very smoothly and economically with a single engine, can provide multi-terrain capability with no hesitation between surfaces of different types of terrains, and can go as fast on the surfaces of water, snow and ice as it can run on the surface of land. Journey between islands, use for arctic expeditions, higher speed entry along inland rivers, and on the other hand, operation on areas of marsh or swamp using lower ground pressure tracks are all effectuated.

Also, by running on the planar surface of water with its tracks, there exists another effect to provide an economic sea-born transportation system having higher transportation efficiency being equivalent to such a required power of cars running on land.

### BRIEF DESCRIPTION OF DRAWINGS

FIG. 1 is a perspective view of a multi-purpose amphibious vehicle according to an embodiment.

FIG. 2 is a schematic representation of the steering, braking and power transmission systems of the multi-purpose amphibious vehicle of FIG. 1.

FIG. 3 is a side view of the multi-purpose amphibious vehicle of FIG. 1.

FIG. 4 is a front view of the multi-purpose amphibious vehicle of FIG. 1.

FIG. 5 is a rear view of the multi-purpose amphibious vehicle of FIG. 1.

FIG. 6 and FIG. 7 are schematic representations of positions of a center of gravity and of a center of pressure of the multi-purpose amphibious vehicle of FIG. 1.

FIG. 8 is a schematic representation of a multi-purpose amphibious vehicle running on the surface of water.

FIG. 9 is a schematic representation of the multi-purpose amphibious vehicle of FIG. 1 self-righting after it has been capsized.

FIG. 10 is a schematic representation of the multi-purpose amphibious vehicle of FIG. 1 wave piercing through a higher wave.

### DETAILED DESCRIPTION OF THE EMBODIMENTS

Starting from the principle in Newtonian physics that “change in momentum is equal to an impulse”, elevation force has been discovered and developed to the principle of All Terrain Ride On Ability as described above and applied to the tracks of an exemplary embodiment of the present invention.

The exemplary embodiment of the present invention will be better appreciated and understood through a review of the attached drawing figures in conjunction with the description set forth as follows.

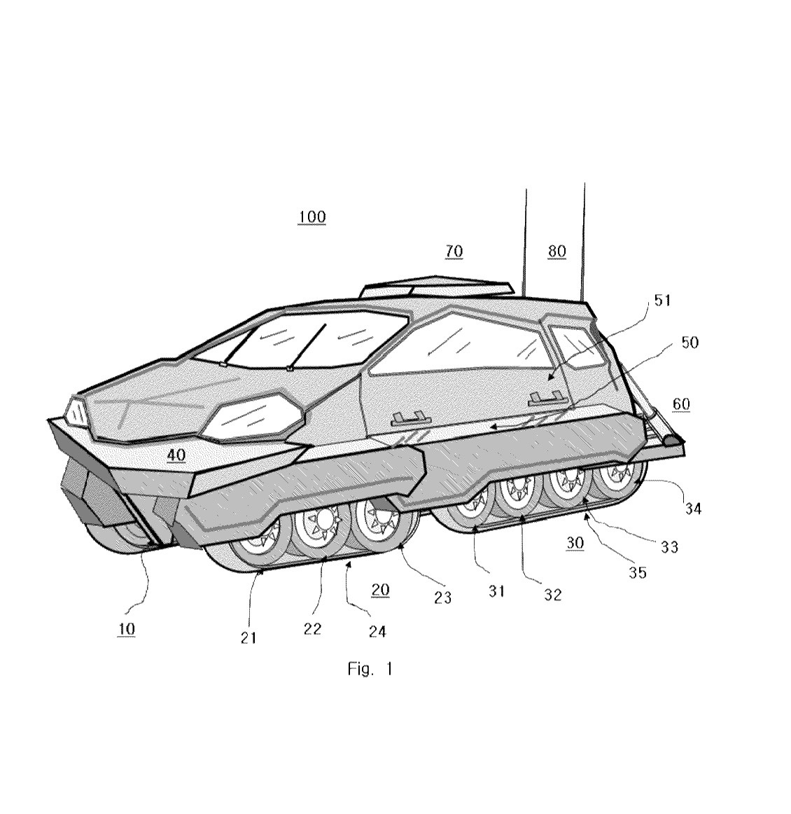

FIG. 1 is a perspective view of a multi-purpose amphibious vehicle 100 according to an embodiment. The multi-purpose amphibious vehicle 100 may include a buoyant bow portion 10 that is constructed as a bow shape of a boat which can go through a current at lower speed in water.

The multi-purpose amphibious vehicle 100 may further include a planing track 20 including a planing belt 24 and 3 sets of idling tires 21, 22, 23, all part of a front part of the vehicle. The multi-purpose amphibious vehicle 100 further may include a traction portion including a driving track 30 that is equipped with four tires 31, 32, 33, 34 and a driving belt 35, all part of a rear part of the vehicle.

On a front upper part of the multi-purpose amphibious vehicle 100, a buoyant fender portion 40 may be constructed in order to prevent the bow of the vehicle from going under during operation.

On each side of the vehicle 100, a hatch door 51 that is water tight and a foothold 50 that passengers can step on may be positioned on an upper side of a track cover.

In the rear of the multi-purpose amphibious vehicle 100, a hatch rear door may be added to provide a total of 3 hatch doors.

In the rear of the multi-purpose amphibious vehicle 100, a hydraulic rear float deck 60 may be deployed to obtain additional buoyancy in order to prevent such a case that a center of pressure is positioned forward of a center of gravity when the vehicle is running at a speed faster than a critical speed. The hydraulic rear float deck 60 may lead to the center of pressure being positioned rearward of the center of gravity. The deck portion of the hydraulic rear float deck 60 may also be used as an extra open space to be used, not only for carrying luggage, but also for connecting a path into the rearward hatch door.

The multi-purpose amphibious vehicle 100 further may include an electronic communication apparatus to confirm the vehicles position at all times. The electronic communication apparatus may be connected to a GPS system including a GPS antenna 70 and a transmission antenna 80 on the top of the vehicle.

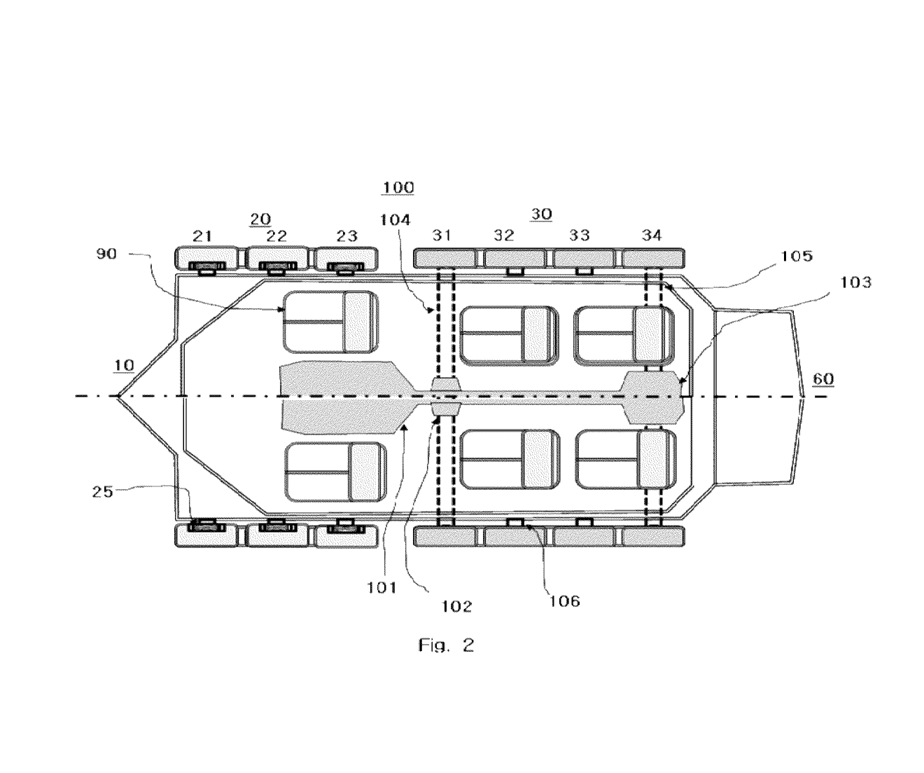

FIG. 2 is schematic representation of the steering, braking and power transmission systems of the multi-purpose amphibious vehicle 100 of FIG. 1. The multi-purpose amphibious vehicle 100 may include the buoyant bow portion 10 that is positioned foremost, 3 sets of idling tires 21, 22, 23 including breaks 25 operated by a hydraulic or electric system. The planing tracks 20 may hydroplane on high waves and may be used for steering and braking. The rear driving track 30 may include 4 sets of tires 31, 32, 33, 34. The front and back sets of tires 31, 34 may transfer power. More specifically, power may be transferred through drive shafts 104, 105 and gear boxes 102, 103 from an engine 101 to the front and back sets of tires 31, 34. The intermediate two sets of tires 32, 33 may be equipped with bearings 106 for idling and guiding wherein the inner pressure of concerned tires may be determined by considering the distributed weight and the contact pressure of the multi-purpose amphibious vehicle 100.

In the rear of the multi-purpose amphibious vehicle, the hydraulic rear float deck 60 is shown deployed so that, when running on the surface of water at a speed faster than the critical speed (i.e., Lee Number is equal to “1”), the center of pressure being generated may be positioned after the center of gravity.

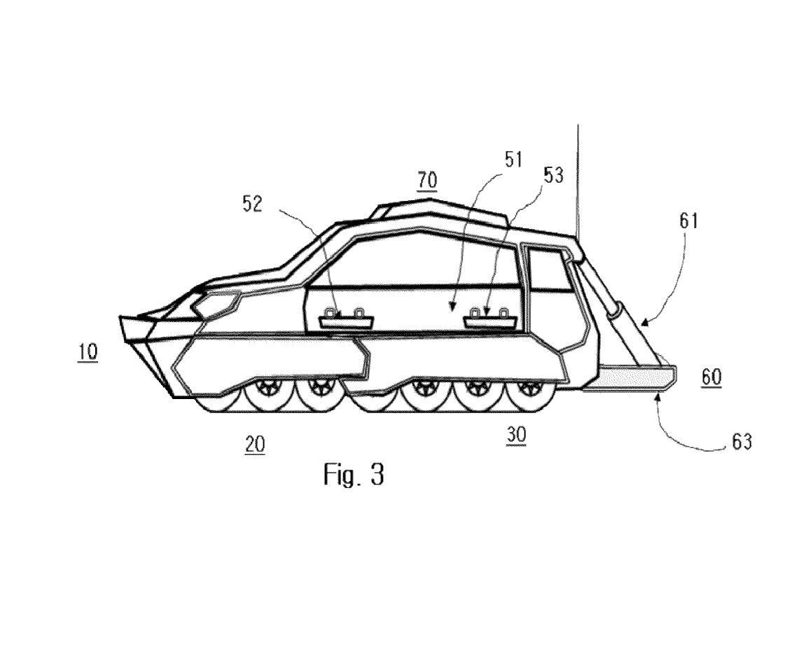

FIG. 3 is a side view of the multi-purpose amphibious vehicle 100 of FIG. 1.

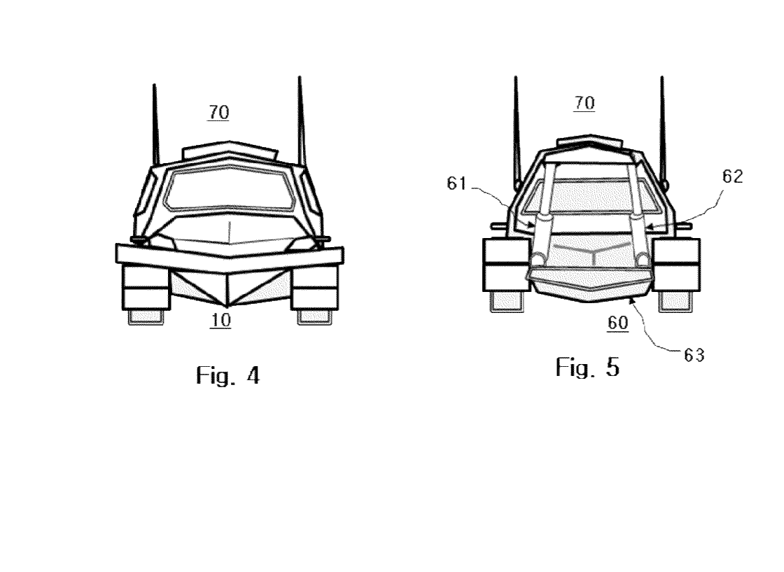

FIG. 4 is a front view of the multi-purpose amphibious vehicle 100 of FIG. 1.

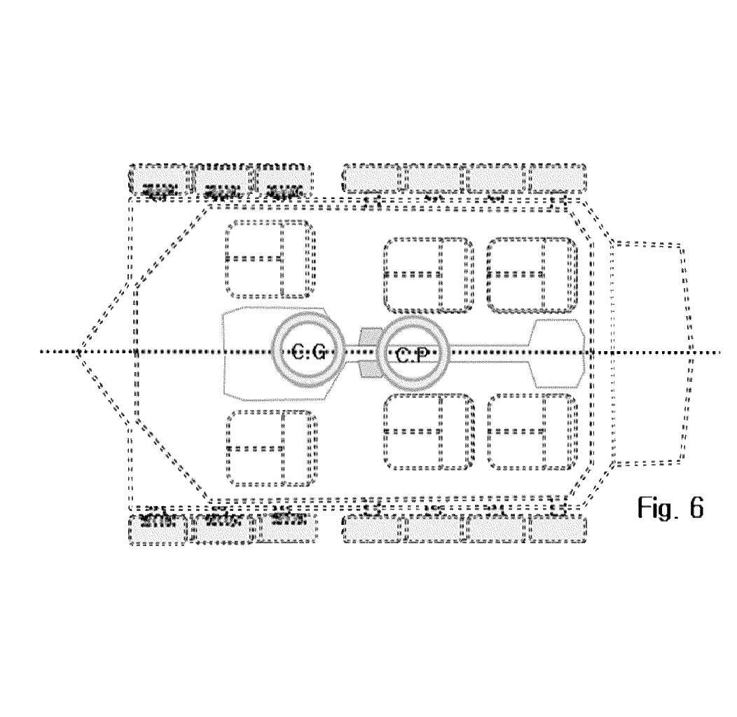

FIG. 5 is a rear view of the multi-purpose amphibious vehicle 100 of FIG. 1.

FIGS. 3-5 show the frontal buoyant bow portion 10 to cleave incoming waves and the driving track 30 when the multi-purpose amphibious vehicle 100 is running faster than the critical speed that is driven by the rolling friction caused between the surface of water and the planing track 20.

On a side hatch door 51, 2 sets of door locks 52, 53 may be set in parallel and provide a water tight seal, and on the hydraulic rear float deck 60, a deployed buoyant plate 63 may be supported by 2 sets of hydraulic cylinders 61, 62. As already noted, the top of the vehicle may include a GPS antenna 70.

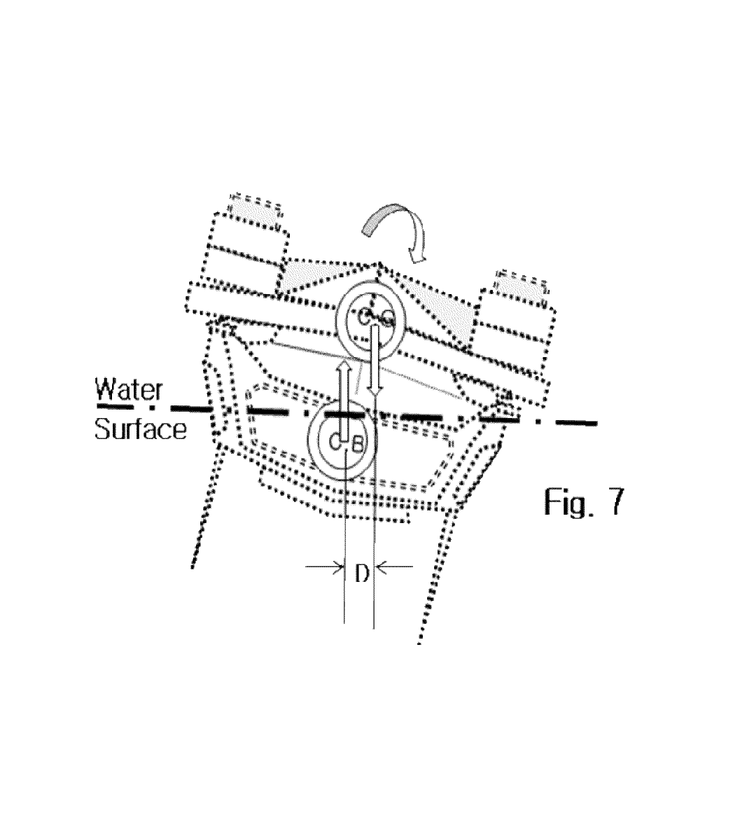

FIG. 6 is a schematic representation showing such a state that the center of gravity of the multi-purpose amphibious vehicle 100 of FIG. 1 may be positioned forward from the center of pressure, which can be realized by adding the rear hydraulic float deck 60 in order to secure the stability of the vehicle when running on the surface of water faster than the critical speed (i.e., its Lee Number is over “1”).

FIG. 7 is a schematic representation demonstrating that a center of gravity of the multi-purpose amphibious vehicle 100 of FIG. 1 due to the weight of the tracks and engine may be positioned at higher point than a center of buoyancy so that the multi-purpose amphibious vehicle 100 is self-righting even after having been capsized.

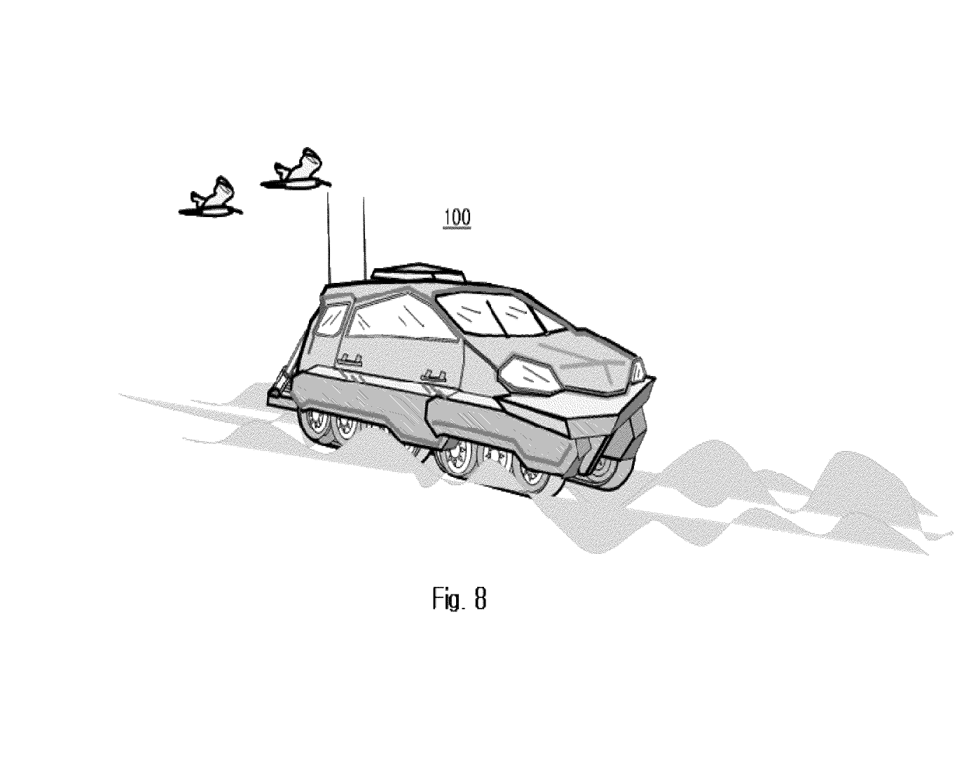

FIG. 8 is a schematic representation showing the multi-purpose amphibious vehicle 100 of FIG. 1 cruising on the surface of water by rolling friction, the elevation force of which may be generated over the critical speed. Exemplary specifications of an embodiment that is cruising as discussed above are described in the following table.

| Specification | Unit | | Remark |
|---|---|---|---|
| Weight | 3,000 | Kg | 6 Pass. Incl. |
| Power | 250 | HP | Water |
| Contact Pressure | 0.055 ^{`} | Kg/cm² | Amphibious |
| Land Max/Cruise | 85/65 | Km/hr | Pavement |
| Water Max/Cruise | 100/75 | Km/hr | Level 2 |
| Critical Speed | 12.1 | Km/hr | On Water |

| | | |
|---|---|---|
| No of Tire | 14 {2 × (3 + 4)} | Aircraft Quality(φ 750 mm) |

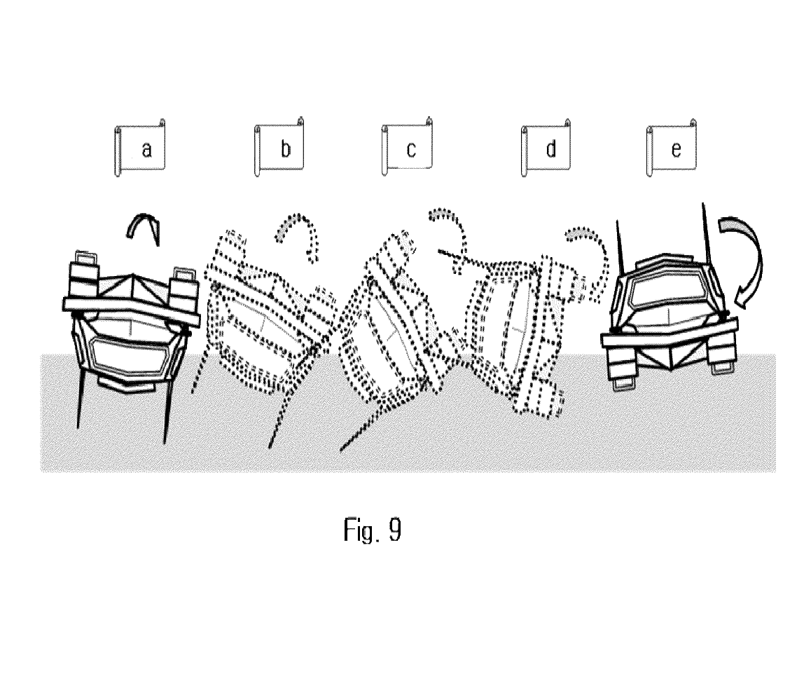

FIG. 9 is a schematic representation showing a series of states in which the multi-purpose amphibious vehicle 100 of FIG. 1 may be self-righting from state “a” (completely upside down) to state “e” (right side up) after having been capsized.

Since the vehicle's center of gravity may be set to be located at higher position than its center of buoyancy after being capsized, even by the slightest leaning, the capsized vehicle is self-righting by the corresponding rolling force, the moment of which is generated from the base point at the center of buoyancy of the capsized vehicle.

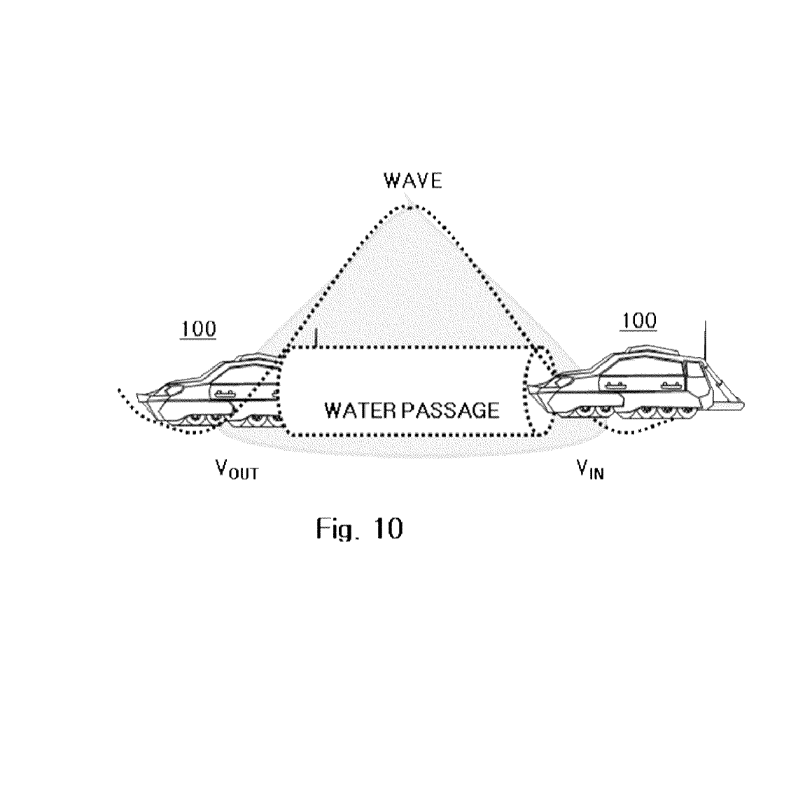

FIG. 10 is a schematic representation of the multi-purpose amphibious vehicle 100 of FIG. 1 going through a wave and to passing through the wave by wave piercing when the vehicle faces a higher wave during movement on the surface of water.

During the period of wave piercing, the forces that are imposed on the multi-purpose amphibious vehicle 100 may be affected by the forces of drag, lift, and self-weight due to gravity. However, the self-weight and buoyancy of the vehicle inside of the wave should be kept in balance. A change of momentum as the vehicle starts to advance into the wave and until it escapes from the wave should be related to the drag force that affects the frontal drag area of the vehicle. The following formula can be derived by:

F_{D}×ΔT=M(V₁−V₂) (Eq. 21)

wherein the average speed of the multi-purpose amphibious vehicle 100 during the wave piercing is given by “Vₘ=½×(V₁+V₂)”. Then, the drag “F_{D}” can be expressed as:

$${F}_{D} = \frac{1}{2} ρ {AV}_{m}^{2} \times {C}_{L} \qquad ( Eq . 22 )$$

Once the wave length of the wave is given by “λ_{W}” and the length of passage for wave piercing is regarded as its half, then its passing time “ΔT” for the water passage is given by the following:

$$Δ T = \frac{\text{?} {λ}_{W}}{{V}_{IN} - {V}_{OUT}} \\ \text{?} \text{indicates text missing or illegible when filed} \qquad ( Eq . 23 )$$

By combining Eqs. 21-23 together, the average speed “Vₘ” of the multi-purpose amphibious vehicle 100 during its wave piercing can be derived by the following:

$${V}_{m} = 2 Δ V \times \sqrt{\frac{M}{ρ A {λ}_{W}}} \qquad ( Eq . 24 )$$

wherein “ΔV=V₁−V₂”.

In the above equation,

$${}_{}^{``}{\sqrt[2]{\frac{M}{ρ A {λ}_{W}}}}{}_{}^{″}$$

is put by “k” and “V₂/V₁” is done by “α”. Then, the following relationship is derived by:

$$α = \frac{{V}_{OUT}}{{V}_{IN}} = \frac{1 - k}{1 + k} \qquad ( Eq . 25 )$$

At this time, “α” exists in “0<a<1”, but “V_{OUT}” should be no less than the critical speed for the multi-purpose amphibious vehicle 100. In case the amplitude and wave length “λ_{W}” is about 10 m, considering that an exemplary cruising speed of the multi-purpose amphibious vehicle 100 on the surface of water may be 75 Km/hr, the wave may cause only a 25% decrease in speed. Thus, even colliding with a higher wave of 10 meters, after about 1 second of a shock absorbing effect, the vehicle can continue to cruise very smoothly.

### INDUSTRIAL APPLICABILITY

Accordingly, this invention that has discovered the Elevation Force from such a law of nature that “Momentum Change Equals to the Impulse” in Newtonian Physics and applies it to the tracks is related to such a multi-purpose amphibious vehicle that is propelled by the principle of All Terrain Ride On Ability. It corresponds with various designs to a wide range of applications from Recreation, Exploration. Search and Rescue up to the Military Purposes.

The applications of this invention can be extended from the commuter going and back to the work along the river of inland, journey between islands, up to the arctic exploration, which is such a multi-purpose amphibious vehicle being built by the advanced technology of All Terrain Ride On Ability that 21^{st} Century has been requiring.

### [Title of the Number]

100: Vehicle
10: bow portion 20: planing Track

### INDUSTRIAL APPLICABILITY

What is claimed is:

1. A multi-purpose amphibious vehicle running, at higher speed over the critical one, on the surfaces of all the terrain, being based upon
such a condition that a certain object (this invention, a multi-purpose amphibious vehicle) can be driven by the rolling friction on a certain surface,
the principle of All Terrain Ride On Ability that is governed by the following “Lee Number”
$${L}_{N} = \frac{V}{g \times Δ T} \qquad ( Eq . 2 )$$
which can judge the generation of Elevation Force that is, starting from “Force” as 2^{nd} law of Newtonian Physics, caused by the momentum change of a certain object and can support the weight of the vehicle at a certain instant,
such a force that a certain revolving object (the track of the concerned vehicle) at an instant when it collides with a certain surface engages with a certain surface (surfaces of all the terrain),
that is, the generated Elevation Force being caused by the principle of All Terrain Ride On Ability that is applied to the forward track and the rear driving track including the tires of radius “R”, which can, over the critical speed, leads a stay at the critical instant and the movement on the surfaces of all terrains at higher speed.

2. The multi-purpose amphibious vehicle of claim 1,
Wherein the concerned track that runs at such a speed
$${V}_{C} = \sqrt{π R \times g}$$
of with a functional relationship between both of its critical speed “V_{c}” and the critical instant “ΔT” and its radius “R” and
that stays during the critical instant
$${}^{``} Δ T {\sqrt{\frac{π R}{g}}}^{″}$$
on surfaces of all terrain by a reactive force being caused from surfaces of all terrain, that is, the elevation force moves naturally at higher speed on surfaces of all terrains by continuously satisfying the mentioned conditions.

3. The multi-purpose amphibious vehicle of claim 1,
Wherein
its forward planning track that includes 3 sets of tire is steered and braked with its braking system,
the fore and back tires among 4 sets of tires inside of the rear driving track are braked and driven by the power of the engine through the driving shaft and the gear box
the said tracks at a time when they contact to surfaces of all terrains, over the critical speed, run at higher speed on surfaces of all terrains in accordance with such a theory of All Terrain Ride On Ability that they are meeting and rotating together with surfaces of all terrains by the rolling friction.

4. The multi-purpose amphibious vehicle of claim 1,
Wherein
The required power at its required maximum speed “U_{Max}” such that the concerned tracks move at higher speed on surfaces of all terrains by planning and driving is obtained by the following formula.
$$HP = \frac{Mg \times {U}_{M ax} + \frac{1}{2} ρ \times {A}_{D} \times {U}_{M ax}^{3}}{η \times 750} \qquad ( Eq . 14 )$$
[In equation 14, “p” is the density of air, “A_{D}” is the area of drag and “η” is the transportation efficiency]
and the concerned vehicle moves on surfaces of all terrains with the most economical transportation efficiency (the one that the vehicle can possess on the highway).

5. The multi-purpose amphibious vehicle of claim 1,
Wherein
the number of tires and the compressed pressure are set in accordance with the distributed weight of the concerned vehicle,
the radius of tires can be computed as
$$R = \frac{g \times Δ {T}^{3}}{π}$$
once the critical instant “ΔT” is designated,
and the planning and driving tracks that include the standardized tires being based upon the above, run at higher speed on surfaces of all terrains.

6. A multi-purpose amphibious vehicle maintaining its driving stability and the self-righting capability
Wherein its center of gravity is positioned further ahead of its center of pressure by adding the hydraulic rear float deck (60) in the rearward of the vehicle,
and in order for the concerned vehicle to manifest the self-righting feature after being capsized, the center of buoyancy should be positioned at lower point than the center of gravity by properly placing its tracks and the weight of engine.

7. A multi-purpose amphibious vehicle that is capable of tunneling the high wave by the wave piercing with the following velocity difference
$$\frac{{V}_{OUT}}{{V}_{IN}} = \frac{1 - k}{1 + k}$$
(wherein
$$k = 2 \sqrt{\frac{M}{ρ A {λ}_{W}}} ,$$
“M” is the mass of the vehicle, “ρ” is the matter density on the contact surface, “A” is the frontal drag area of the vehicle, and “λw” is the wave length of the wave), while this invention being applied for the principle of All Terrain Ride On Ability is running at higher speed than the critical one on surfaces of all terrain.
